(19) United States
(12) Patent Application Publication
(10) Pub. No.: US 2010/0117459 A1
(43) Pub. Date: May 13, 2010

(54) Poka Yoke Design For Reminding The User To Disconnect The Shore Power From The APU Before Opening The Cover

(75) Inventors: Yogesh Dharmadhikari, Fort Wayne, IN (US); Sabrina Omar, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 12/269,925

(22) Filed: Nov. 13, 2008

(51) Int. Cl. F16P 3/20

(52) U.S. Cl. 307/328

(57) ABSTRACT

The catch for an auxiliary power unit cover comprises a bracket which has an opening therein sized and configured to receive shore power receptacles of the unit within the opening, the bracket being engaged to and extending outwardly of the cover, and over the receptacles, such that the cover cannot be removed while shore power lines remain engaged within the receptacles therefor.

### BACKGROUND OF THE INVENTION

1. Field of the Invention

The present invention relates to a catch for an auxiliary power unit cover which requires disengagement of shore power lines engaged to the unit to allow removal of the cover.

2. Prior Art

To date it is not believed that any such catch for an auxiliary power unit cover exists.

### SUMMARY OF THE INVENTION

A catch for an auxiliary power unit cover comprises a bracket which has an opening therein sized and configured to receive shore power receptacles of the unit within the opening, the bracket being engaged to and extending outwardly of the cover, and over the receptacles, such that the cover cannot be removed while shore power lines remain engaged within the receptacles therefor.

### BRIEF DESCRIPTION OF THE DRAWINGS

FIG. 1 is a perspective view of an auxiliary power unit, wherein a cover thereof is engaged thereon, with the catch of the present invention engaged to the cover, seated over shore power receptacles of the unit, showing power cables extending through an opening in the catch and engaging the receptacles of the unit.

FIG. 2 is a perspective view similar to FIG. 1, except that the shore cables are now disengaged from the receptacles therefor.

FIG. 3 is a perspective view similar to FIGS. 1 and 2, except that the cover is now capable of being removed, after disengagement of the shore power cables.

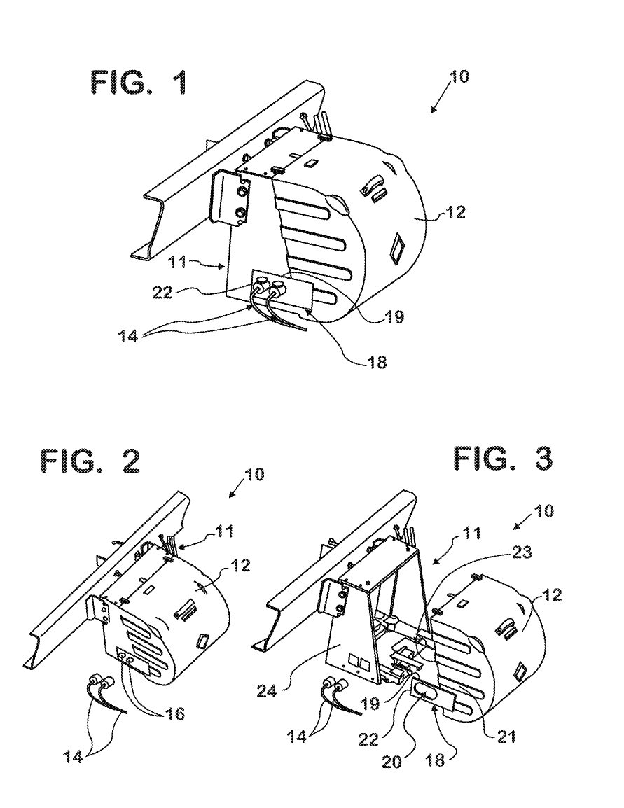

### DESCRIPTION OF THE PREFERRED EMBODIMENT

Preferring now to the drawings in greater detail, there is illustrated therein an auxiliary power unit 10 incorporating a housing 11 to which is removably engaged a cover 12.

When the cover 12 is removed, access is provided to internal components of the unit 10, some of which are high voltage components.

Thus, there has been identified a need to assure that the cover 12 is not capable of being removed until shore power cables 14, engaged to receptacles 16 of the unit 10, are disengaged.

To meet this need, it is proposed herein to provide a catch 18 for the cover 12.

The catch 18 is in the form of a bracket 18, having a frame like body 19 including an opening 20 therein, which bracket 18 is mechanically engaged to the cover 12 at a position where the opening 20 of the bracket 18 will overlie the receptacles 16 when the cover 12 is engaged appropriately to the housing 11. As illustrated, the catch 18, extends longitudinally outwardly from a side wall 21 of an open edge 23 of the cover 12, which open edge 23 removably engages within the housing 11 of the unit 10. The body 19 of the bracket 18 is stepped slightly laterally outwardly of the side wall 21 so as to be positionable in a manner where the opening 20 therein overlies the receptacles 16 located on a side wall 24 of the unit 10.

Once at least one power cord 14 is engaged to one respective receptacle 16, extending through the opening 20 of the catch 18, the cover 12 is virtually “locked on,” until the at least one power cord 14 is disengaged.

The catch 18 has a substantially planar, rather elongate, rectangular configuration to body 19 and the central opening 20 therein is sufficiently large to allow access to the receptacles 16 therethrough, with the body 19 of the catch 18 effectively framing the receptacles 16. The catch 18, has a closed free end 22 which cannot pass across the receptacles 16 so long as power cords 14 are engaged, due to the framing configuration of the body 19 thereof.

Once the power cables 14 are removed, the free end 22 of the catch 18 can now pass across the receptacles 16, allowing the cover 12 to be removed.

As described above, the catch 18 of the present invention has a number of advantages, some of which have been described above and others of which are inherent in the invention. Also, modifications may be proposed to the catch 18 without departing from the teachings herein. Accordingly, the scope of the invention is only to be limited as necessitated by the accompanying claims.

1. A catch for ensuring that a cover of an auxiliary power unit cannot be removed until shore power cables are disengaged from receptacles of the unit, comprising a bracket fixedly engaged to the cover at a position to overlie receptacles provided on a housing of said auxiliary power unit, the cover removably engageable to the housing, the bracket being in the form of a frame and having an opening therein sized and configured to allow access to the receptacles when engaged thereover, the frame configuration of the bracket interfering with passage thereof over the receptacles so long as at least one shore power cable is engaged to at least one of said receptacles.

2. The catch of claim 1 being engaged to and extending outwardly from an open end edge of the cover, which open end edge is engageable to said housing.

3. The catch of claim 2 wherein said catch is stepped laterally outwardly of said open end edge of said cover so as to overlie the receptacles of the unit provided on the housing thereof.

4. The catch of claim 1 wherein the opening allows access to the receptacles and wherein said bracket includes a free end wall which cannot pass across the receptacles until all shore power cords are disengaged from the receptacles.

5. The catch of claim 1 extending longitudinally outwardly from a side wall of the cover at a position where the bracket frames the receptacles within the opening therein.
